(19) United States
(12) Patent Application Publication
(10) Pub. No.: US 2016/0264211 A1
(43) Pub. Date: Sep. 15, 2016

(54) Swing Arm Extender

(71) Applicant: Twist Initiative, LLC, Riverview, FL (US)

(72) Inventor: Robert Runman, New Port Richey, FL (US)

(73) Assignee: Twist Initiative, LLC, Riverview, FL (US)

(21) Appl. No.: 14/644,925

(22) Filed: Mar. 11, 2015

(51) Int. Cl. B62K 25/28; B62D 65/02

(52) U.S. Cl. CPC B62K 25/283; B62D 65/02

(57) ABSTRACT

A swing arm extender includes a body portion having a first side and a distal second side. The first side has a shape and size for interfacing with a frame of a bike/trike at a location where a stock swing arm previously interfaced to the frame of the bike/trike and the second side (opposing the first side) has a size and shape for interfacing with the stock swing arm. There are seats in the first side where bearings are installed, and then a stock pivot pin is passed through the bearings and the frame of the bike/trike. The bearings enable pivoting of the swing arm extender at a point between the frame of the bike/trike and the first side

### FIELD

This invention relates to the field of vehicles and more particularly to a swing arm extender for extending a location of the rear wheel(s) of a vehicle.

### BACKGROUND

A swing arm is a primary component of the rear suspension of most motorcycles. Swing arms typically allow for pivotal motion to allow the rear wheel latitude when riding on an uneven surface (e.g., bumps). Swing arms are manufactured in a variety of configurations with various dampening methods (shock absorption). Some swing arms have a swinging fork in which the rear tire is mounted on an axle between two tines of the swinging fork, and a distal end of the swinging fork has a pivot attachment to the frame. Other swing arm architectures include a cantilever, a parallelogram suspension, and a single-sided swing arm.

The single-sided swing arm allows the rear wheel to be mounted in a way that is similar to an automobile wheel, and the drive is typically a drive chain or belt interfacing the transmission to the rear wheel. The single-sided swing arm allows many different sized tires to be adapted to a particular bike/trike, as the tire does not need to fit between the tines of a fork. One limitation of the tire size is the clearance between the axle of the tire and other bike/trike frame members, seats, etc.

Many bike/trike owners prefer to customize the configurations of their bike/trike for different riding experiences and different looks. Bike/trike manufacturers typically provide a standard configuration that appeals to many, but many owners prefer different riding experiences, different looks, different centers-of-balance, and different sized tires, in particular rear tires.

One way to customize a bike/trike is to extend the distance between the wheels and one way to do such is to extend the rear wheel. Be extending the wheel base, a totally different ride is achieve, a different center-of-gravity is made, as well as a different appearance. Once the rear axle is extended, in bikes/trikes with single-sided swing arms or the like, larger rear tires are possible to improve ride stability, comfort, tire friction, tread, etc.

In the past, extending the rear wheel of a bike/trike included welding of new suspension members to the existing frame of the bike/trike. While this worked, the reliability of the rear suspension was now dependent upon the quality of the welds and the resale value of the bike/trike is potentially compromised being that the modified bike/trike is often not appealing to purchasers seeking a stock version of the bike/trike. Further, the task of welding requires significant skill, such skill often lacking in the typical bike/trike owner, thereby requiring modification by a mechanic/welder.

What is needed is a swing arm extender that is robust, easy to install, and easily removed.

### SUMMARY

In one embodiment, a swing arm extender is disclosed including a body portion having a first side and a distal second side. The first side has a shape and size for interfacing with a frame of a bike/trike at a location where a stock swing arm previously interfaced to the frame of the bike/trike and the second side (opposing the first side) has a size and shape for interfacing with the stock swing arm. There are seats in the first side where bearings are installed, and then a stock pivot pin is passed through the bearings and the frame of the bike/trike. The bearings enable pivoting of the swing arm extender at a point between the frame of the bike/trike and the first side.

In another embodiment, a method of increasing the wheel base of a bike/trike is disclosed including removing a stock pivot pin that pivotally holds the stock swing arm of the bike/trike to a frame of the bike/trike, then removing stock shaft bearings from seats in the stock swing arm. Next, the stock shaft bearings are installed into second seats in a swing arm extender and the stock pivot pin is passed through the stock shaft bearings and through the frame, thereby pivotally connecting the swing arm extender to the frame of the bike/trike. Next, the swing arm extender is connected to the stock swing arm of the bike/trike, for example with a round pin.

In another embodiment, a swing arm extender is disclosed including a body portion having a first side and a second side. The first side has a shape and size for interfacing with a frame of a bike/trike at a location where a stock swing arm previously interfaced to the frame of the bike/trike and the second side (opposing the first side) has a size and shape for interfacing with the stock swing arm. Seats in the first side accept bearings taken from the stock swing arm and a stock pivot pin is passed through the bearings, enabling pivoting of the swing arm extender at a point between the frame of the bike/trike and the first side.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a top view of a swing arm extender.

FIG. 2 illustrates a side view of the swing arm extender.

FIG. 3 illustrates a rear view of the swing arm extender.

FIG. 4 illustrates a top view of the swing arm extender installed on a trike/bike.

FIG. 5 illustrates a side view of the swing arm extender installed on a trike/bike.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

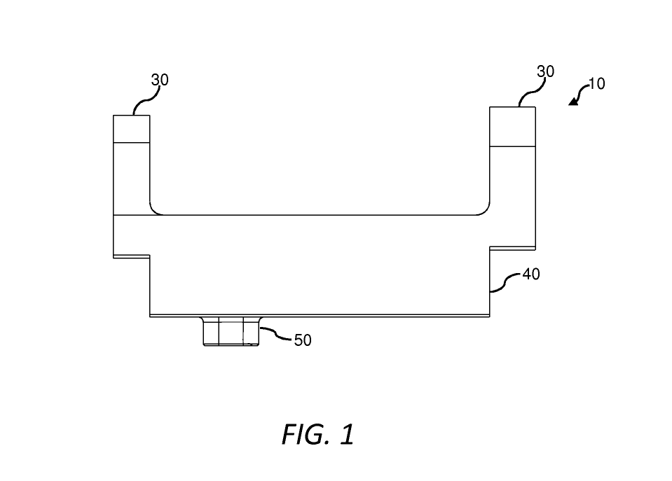

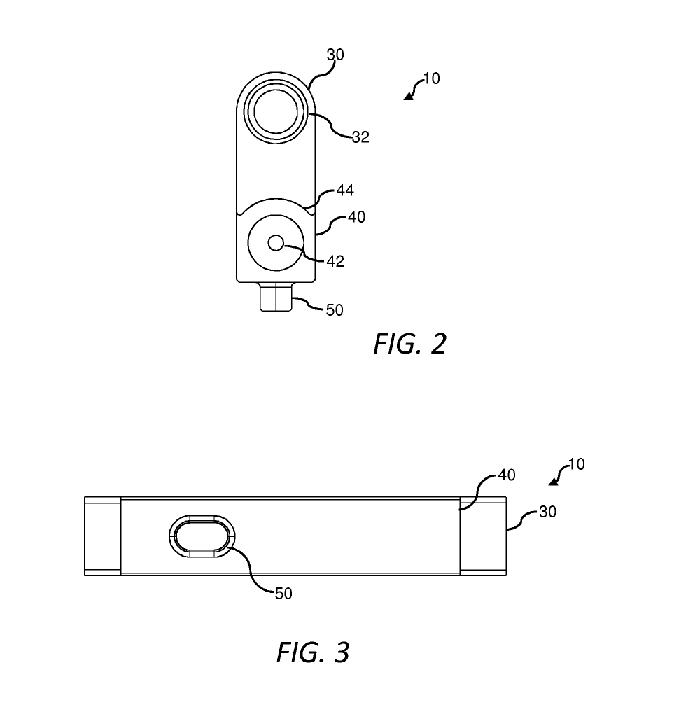

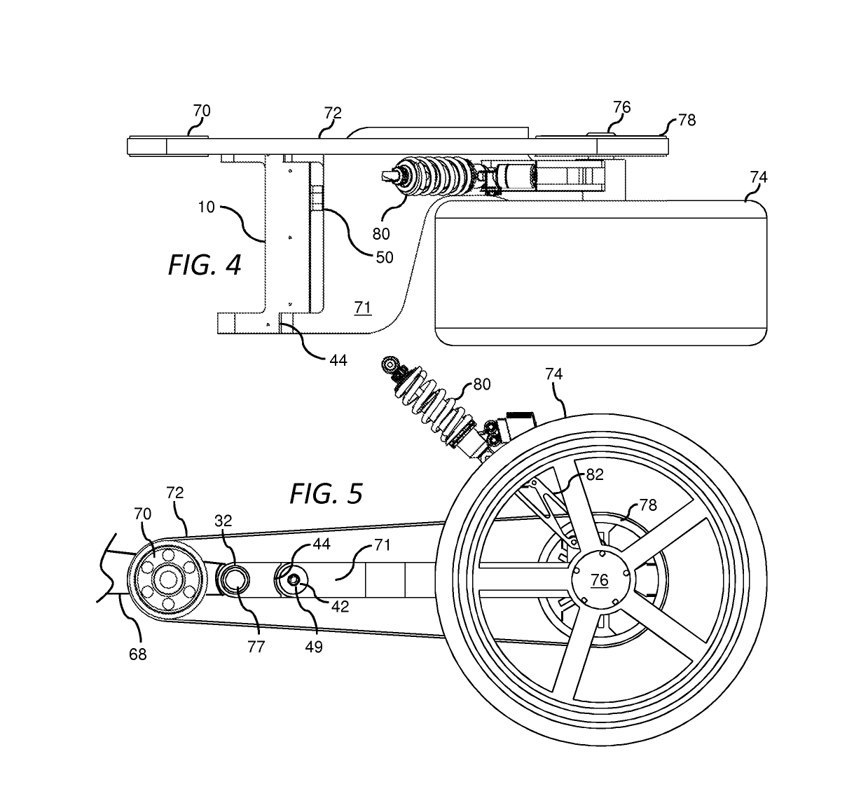

Referring to FIGS. 1-3, views of a swing arm extender 10 are shown. The swing arm extender 10 is basically a structural member that has geometries that are similar to the geometries of the interface at the bike/trike frame. In such, one side 30 of the swing arm extender 10 interfaces to the bike/trike frame 68 (see FIG. 5) taking the place of the stock swing arm 71 (see FIGS. 4 and 5) and a distal side 40/44 accepts the stock swing arm 71, thereby extending the rear wheel 74 (see FIGS. 4 and 5) by a distance that is approximately the same as the distance from the front surface 30 of the swing arm extender 10 to the rear interface surface 44 of the swing arm extender 10.

Although not required to be exact, the contour (e.g. curvature) of the front surface 30 of the swing arm extender 10 is made to match the contour (e.g. curvature) of the bike/trike frame 68 while the contour (e.g. curvature) of the swing arm interface surface 44 is made to match the contour (e.g., curvature) of the stock swing arm 71. By matching the contours, the swing arm extender 10 maintains a similar structural integrity as was before when the stock swing arm 71 was installed to the bike/trike frame 68.

To further improve the structural properties of the swing arm extender 10, when the stock swing arm 71 includes a keyhole (not visible), a key 50 is formed on the swing arm extender 10 to engage with the keyhole of the stock swing arm 71, thereby improving structural integrity and further limiting any rotational movement around the round pin 49.

It is anticipated that the swing arm extender 10 be made of a sturdy, stiff material such as steel or aluminum, though there is no limitation on the actual material.

The stock shaft bearings 33 are removed from the stock swing arm 71 and, as shown in FIG. 1, the stock shaft bearings 33 are installed in the seats 32 of the swing arm extender 10. The swing arm extender 10 is coupled to the stock swing arm 71 by, for example, round pins 49 in aperture 42, holding the swing arm extender 10 rigid against the stock swing arm 71. The stock swing arm 71 is joined and locked into the swing arm extender 10 by virtue of the shape of the interface (curvature) and/or by the key 50 of the swing arm extender 10 interfacing within a keyhole of the stock swing arm 71. The stock pivot pin 77 is inserted through the bearings 33 and through the frame 68 (see FIG. 5), allowing pivotal motion of the stock swing arm 71 and the swing arm extender 10.

Referring to FIGS. 4 and 5, views of the swing arm extender 10 are shown installed on a trike/bike. Stock swing arm 71 was removed from the trike/bike frame 68 and the bearings 33 and stock pivot pin 77 removed from the stock swing arm 71 and installed into the bearing fitting 32 of the swing arm extender 10. The swing arm extender 10 is now pivotally attached to the bike/trike frame 68 by way of the stock bearings 33 and stock pivot pin 77. The swing arm extender 10 is non-pivotally attached to the stock swing arm 71 by a round pin 49 or any other suitable fastener passing through the stock swing arm 71 and the swing arm extender 10. In some embodiments, pivoting at the round pin 49 is precluded by way of the shape of the end surface of the swing arm extender 10, while, in stock swing arms 71 having key holes, a key 50 formed on the surface of the swing arm extender 10 extends into the key hole, preventing any pivoting motion between the swing arm extender 10 and the stock swing arm 71.

Typically, a drive wheel or sprocket 70 is positioned towards the rear area of the bike/trike frame 68 for connection to a belt 72 or chain 72. The belt 72 or chain 72 is removed to install the swing arm extender 10 and replaced with a longer belt 72 or chain 72, or links are added to the chain 72. The belt 72 or chain 72 is reinstalled, interfacing with a mating wheel 78 or sprocket 78 that is coupled to the rear wheel 74.

Being that the rear wheel 74 is now further from the frame 68 (further than when the bike/trike was in a stock configuration), the shock absorption system 80 (e.g., spring and gas cylinder) will typically not reach the rear wheel assembly. To properly connect the shock absorption system 80, in some embodiments a shock system extender 82 is provided to accommodate the added distance between the frame 68 and the rear wheel 74.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A swing arm extender comprising:
a body portion;
a first side of the body portion, the first side having a shape and size for interfacing with a frame of a bike/trike at a location where a stock swing arm previously interfaced to the frame of the bike/trike;
a second side of the body portion, opposing the first side, the second side having a size and shape for interfacing with the stock swing arm; and
seats in the first side with bearings installed in the seats and a stock pivot pin passing through the bearings and the frame, the bearings and stock pivot pin enabling pivoting of the swing arm extender at a point between the frame of the bike/trike and the first side.

2. The swing arm extender of claim 1, wherein the second side further comprises a key, the key mates with a keyhole of the stock swing arm, thereby preventing rotation of the stock swing arm with respect to the swing arm extender.

3. The swing arm extender of claim 1, wherein the second side is held in place with the stock swing arm by a round pin.

4. The swing arm extender of claim 1, wherein a shock absorption system extender is inserted between the stock swing arm and the stock shock absorption system.

5. A method of increasing the wheel base of a bike/trike comprising:
removing a stock pivot pin that pivotally holds the stock swing arm of the bike/trike to a frame of the bike/trike;
removing stock shaft bearings from seats in the stock swing arm;
installing the stock shaft bearings into second seats in a swing arm extender;
inserting the stock pivot pin through the stock shaft bearings and through the frame of the bike/trike, thereby pivotally connecting the swing arm extender to the frame of the bike/trike; and
connecting the swing arm extender to the stock swing arm of the bike/trike.

6. The method of claim 5, further comprising a step of removing a drive chain from between a sprocket on the frame of the bike/trike and a sprocket interfaced to a wheel, the wheel rotatably attached to the stock swing arm.

7. The method of claim 6, further comprising a step of installing a second drive chain between the sprocket on the frame of the bike/trike and the sprocket interfaced to the wheel, whereas the second drive chain is longer than the drive chain.

8. The method of claim 5, wherein the step of connecting the swing arm extender to the stock swing arm of the bike/trike includes installing a round pin into an interface between the swing arm extender and the stock swing arm.

9. The method of claim 8, wherein the interface between the swing arm extender and the stock swing arm comprises a key that inserts into a key hold, reducing pivotal ability between the swing arm extender and the stock swing arm.

10. The method of claim 5, further comprising the steps of:
disconnecting a stock shock absorption system from the stock swing arm, the stock shock absorption system interfaced between the frame of the bike/trike and the stock swing arm;
connecting a shock absorption system extender between the stock shock absorption system and the stock swing arm.

11. A swing arm extender comprising:
a body portion;
a first side of the body portion, the first side having a shape and size for interfacing with a frame of a bike/trike at a location where a stock swing arm previously interfaced to the frame of the bike/trike;
a second side of the body portion, opposing the first side, the second side having a size and shape for interfacing with the stock swing arm; and
seats in the first side, bearings installed in the seats and a stock pivot pin passing through the bearings, the bearings enabling pivoting of the swing arm extender at a point between the frame of the bike/trike and the first side.
